(19) United States
(12) Patent Application Publication
(10) Pub. No.: US 2013/0327126 A1
(43) Pub. Date: Dec. 12, 2013

(54) POROSITY MEASUREMENT

(71) Applicant: Jussi Graeffe, Kyroekoski (FI)

(72) Inventor: Jussi Graeffe, Kyroekoski (FI)

(73) Assignee: METSO AUTOMATION OY, Vantaa (FI)

(21) Appl. No.: 14/000,672

(22) PCT Filed: Feb. 29, 2012
(86) PCT No.: PCT/FI2012/050201

§ 371 Date: Aug. 21, 2013

(30) Foreign Application Priority Data
Mar. 2, 2011 (FI) 20115209

(51) Int. Cl. G01N 15/08

(52) U.S. Cl. CPC G01N 15/082
USPC 73/38

(57) ABSTRACT

The measuring device is an on-line measuring device including a pressure generator and a sensor, by which is determined porosity of paper or board, constituting an object of measurement, by directing known suction effect to the paper or board and measuring low pressure produced by the suction effect for the determination of porosity.

### FIELD

The invention relates to a device and a method for porosity measurement, and a control arrangement and a control method based thereon.

### BACKGROUND

Paper contains fibres and various fines and filler particles, which are tightly compressed when the paper is made. Between particles, and often also inside fibres, there are still tiny air channels and cavities, which render the paper porous.

Porosity of paper may be defined, for instance, by measuring air permeability of paper, for which there are several standardized measurement methods, such as ISO 5636-1, ISO 5636-2, ISO 5636-3 and 5636-4. The measurement may be carried out as on-line measurement on a moving paper web during the manufacturing of paper, or as off-line measurement on an immovable sample of paper in the laboratory.

In most standards of the paper field the measurement is performed by means of low pressure in such a manner that a low-pressure generator generates the low pressure between a measuring head and the paper. The low pressure is measured by a sensor and in the measurement it is of importance that through pressure measurement the low-pressure generator will be controlled to produce a predetermined constant low pressure, which is accurately defined in the standard, between the measuring head and the paper. When said predetermined low pressure is achieved, a flow rate of gas through paper will be measured towards the low-pressure generator. As the pressure of gas is made constant, a change in the porosity of paper will change the flow rate of gas (ml/min). Consequently, the porosity of paper may be determined by the measured flow rate of gas.

Current on-line meters are manufactured in compliance with these laboratory methods for measurement. However, the standard on-line measurement thereof involves problems. A predetermined constant pressure for determining a flow rate of air is difficult to provide and maintain accurately, particularly in on-line measurement, in which both the paper and the measuring head move continuously. Inaccuracy of pressure control and uncontrollable variation in low pressure reduce the accuracy of measurement. To obtain a predetermined pressure requires continuous regulation, which causes a delay in the measurement. The continuous regulation of the measuring pressure wears a regulator which controls the low-pressure generator and which needs to be replaced by a new one in about every six months, for instance, due to wearing and breaking.

In addition, any low-pressure pump incorporating moving mechanical parts is sensitive to dirt and dust. Dirt and dust disturb the operation of the pump and may even block the pump, because they adhere to the mechanical parts of the pump. Moisture makes things worse, because in that case dirt and dust stick to the mechanical parts even more easily and tightly. Moisture as such also impedes the operation of the pump, because moisture or condensed water may cause short-circuits, malfunctions and/or damages in the electrical components. The moving mechanical parts may also suffer from moisture. The operation of the pump being disturbed, the measurement of porosity becomes more difficult or it will be impossible to measure it at all. A conventional flow meter, which is based on filament resistance, is also sensitive to moisture and dust, because the filament resistance depends on moisture and dust. The filament is also easily broken because of moisture and dust. For these reasons, inter alia, the measuring device employs one or more filters, which are to prevent access of moisture and dust into the measuring device. Filtering is not completely thorough, however, and thus pumps and flow meters break down due to moisture and dirt. Apart from the filter impeding the air flow and thus deteriorating the accuracy of measurement, the filter fouls very quickly, for instance, when porosity is to be measured prior to coating in moist conditions. Thus, the filter is to be changed or emptied often at least once a day, which interrupts the porosity measurement and requires resources. Finally, it may further be stated that when measurement is performed on extremely dense paper, the flow rate is so low that the measurement thereof poses problems. For these reasons, inter alia, there is a need to develop porosity measurement.

### BRIEF DESCRIPTION

The object of the invention is to provide an improved solution. This is achieved by a measuring device of claim 1.

The invention also relates to a measuring method in accordance with claim 11.

The invention further relates to a control arrangement in accordance with claim 21.

The invention still further relates to a control method in accordance with claim 23.

Preferred embodiments of the invention are disclosed in the dependent claims.

The measuring device of the invention does not require a flow meter, which makes porosity measurement more accurate and simpler.

### LIST OF FIGURES

The invention will now be described in greater detail in connection with preferred embodiments, with reference to the accompanying drawings, in which:

FIG. 1A illustrates a principle of measurement,

FIG. 1B shows separate measurements to be performed on a plurality of different flow channels,

FIG. 2 shows a common measurement to be performed on a plurality of flow channels,

FIG. 3 shows a measuring device having an ejector,

FIG. 4 shows a measuring device which may be calibrated by measuring a porosity reference,

FIG. 5A shows a measuring device including contact means for holding the object of measurement in contact with the measuring head during measurement,

FIG. 5B shows the ejector which is in contact with the object of measurement,

FIG. 6 illustrates the operation of a pressure generator,

FIG. 7 shows an example of the structure of the measuring device,

FIG. 8 illustrates porosity measured by the measuring device and porosity measured according to a standard,

FIG. 9 shows a paper machine,

FIG. 10 is a flow chart of the measuring method and

FIG. 11 is a flow chart of the control method.

### DESCRIPTION OF EMBODIMENTS

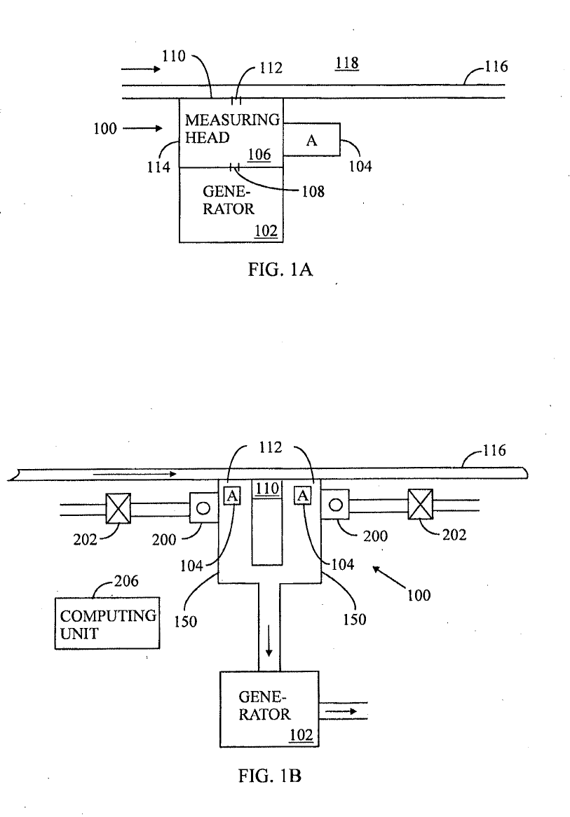

At first on-line porosity measurement is examined by means of FIG. 1A. A measuring device may determine the porosity of paper or board, constituting the object of measurement 116, by exposing the paper or the board to a known and/or predetermined suction effect and by measuring the low pressure produced by the suction effect, the value of which is based on porosity. In this context the predetermined suction effect I refers to a quaantity that may observe a predetermined function F, dependent on flow rate q and low pressure P, such that I=F(q, P). In a simple case, the predetermined function F may be a product of the flow rate and the pressure F(q, P)=aqP, where a is a constant that may be determined experimentally, for instance.

The measuring device may comprise a pressure generator 102 and a sensor 104. The measuring device may thus determine the porosity of the paper or board, constituting the object of measurement 116, by directing suction with the pressure generator 102 at a predetermined strength to the object of measurement 116 and by measuring the low pressure produced by said suction with the sensor 104.

The low pressure P may be determined by a pressure difference over the object to be measured 116. In that case, in the surroundings 118 of the object of measurement 116, where normal atmospheric pressure often prevails, the pressure is higher than on that side of the object of measurement 116 where low pressure is measured with the sensor 104. In this document the low pressure may refer to a pressure difference over the object of measurement 116 or a pressure that is measured with the sensor 104. For determining the low pressure it is also possible to measure the ambient pressure 118, or it may be assumed known.

Generally, the measuring device may comprise at least one measuring head 100, at least one pressure generator 102 and at least one sensor 104. The measuring head 100, the outer surface of whose contact part 110 is intended to be in contact with the object of measurement 116, may incorporate a measuring space 106, but a separate measuring space 106, in particular, is not necessary. Particularly, there is no separate measuring space 106, if, for instance, the pressure generator 102 communicates directly with at least one port 112 of the contact part 110. In that case the pressure generator 102 may be connected to at least one port 112 directly or, for instance, through at least one gas conduit 150.

The surface 114 of the measuring head 100 may be made of material impermeable to gas. The material may be metal, for instance. The contact part 110 may be made of e.g. steel, ceramics, diamond, sapphire or a combination thereof. The material of the contact part 110 may be a combination of metal and ceramics, for instance, in which case the steel may constitute the body and the ceramics may constitute the outer surface in order to reduce wearing. The object of measurement 116 may be paper, board or a combination thereof.

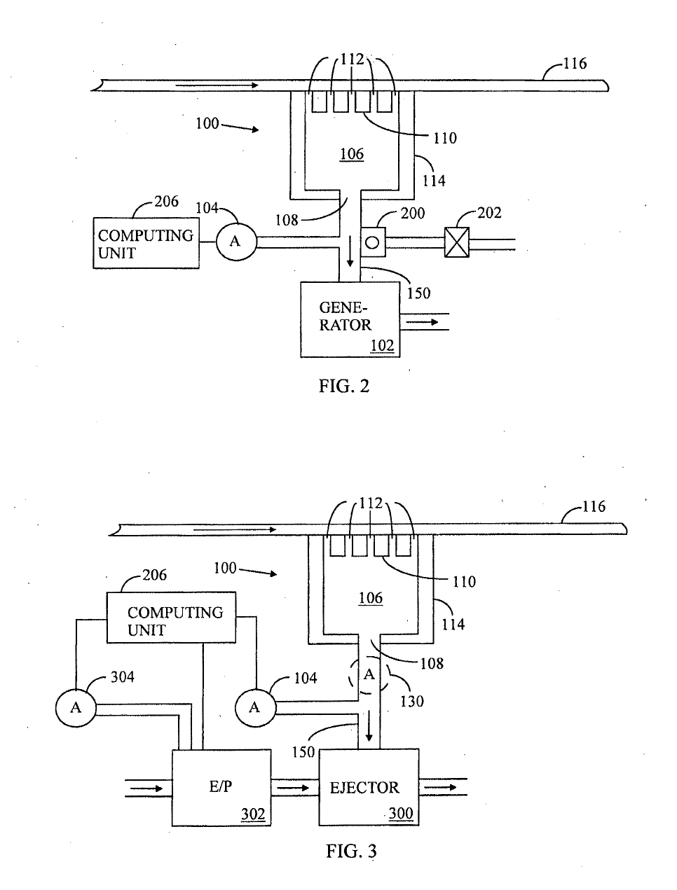

When the measuring head 100 comprises a measuring space 106, the surface 114 comprises a pressure opening 108 for gas flow between the pressure generator 102 and the measuring space 106. The measuring head 100 and the pressure generator 102 may be directly interconnected, but between the measuring head 100 and the pressure generator 102 there may also be a gas conduit 150 for gas flow (shown e.g. in FIG. 2), one end of which is connected to the pressure opening 108 of the measuring head and the other end to the pressure generator 102. The gas conduit 150 may be a pipe and its material may be metal or plastic, for instance. The surface of the gas conduit 150 may be coated with soil-repellent materials. The pressure opening 108 or the port 112 and the pressure generator 102 may be conceived to also comprise an appropriate connector for each gas pipe.

In its contact part 110 the measuring head 100 comprises at least one port 112, through which the gas may flow after passing through the object of measurement 116. The total area of one or more ports 112 may be predetermined, for instance, for the measurement in accordance with a desired standard. The area of one or more ports 112 may also be adjustable.

The pressure generator 102 is intended to work at a predetermined operating efficiency. The pressure generator 102 is a gas pump which is capable of providing a gas flow of predetermined magnitude when operating with unchanged efficiency against known flow resistance. The known pressure may be low pressure produced in relation to the pressure prevailing on the opposite side 118 of the object of measurement 116. The higher the flow resistance, through which the pressure generator 102 pumps gas, the lower the gas flow the pressure generator produces, yet the interdependence of the gas flow and the pressure is predetermined all the time. It is conceivable that the constant power P of the pressure generator may be expressed as P=Δpq, where Δp is a pressure difference over the object of measurement 116 acting as resistance and q is a gas flow rate. Thus, the flow rate q will be q=P/Δp. This, in turn may be expressed as q=P/(p₀−pₘ), because Δp=p₀−pₘ, where pₘ is a measured pressure, p₀ is a known pressure (e.g. atmospheric pressure or pressure in a gas container on the opposite side 118 of the object of measurement 116). The flow rate curve would thus be a hyperbola, yet an ejector, for instance, has the highest possible flow rate Qₘₐₓ. In addition, in the ejector, for instance, the flow rate behaves mostly linearly in relation to the pressure difference Δp, for instance, q=a(P)Δp, where a(P) is a coefficient depending on the pressure P. Generally, the flow rate q may be expressed by a predetermined formula q=f(Δp), where f is a known function. The function f may be based on a theory, simulation or measurements. So, if the pressure pₘ provided by the pressure generator 102 is measured, it is also possible to determine the amount of gas flow provided by the pressure generator 102 (e.g. in unit cm³/min), when a predetermined operating efficiency P is used in the pressure generator 102. The operating efficiency refers here to the capability of the pressure generator of moving or sucking gas out of each flow channel 112. The pressure generator 102 thus draws gas away from the object of measurement at a predetermined suction force, whereby gas flows through the porous object of measurement 116 in the larger amount, the more porous the object of measurement 116.

In the presented solution, the pumping of the pressure generator 102 is resisted by the object of measurement 116, and the amount of gas flow passing therethrough is proportionate to the porosity of the object of measurement. The gas flow through the object of measurement 116 and the predetermined operating efficiency of the pressure generator 102 thus provide an equilibrium in which a low pressure depending on the porosity of the object of measurement 116 prevails between the contact part 110 and the pressure generator 102. The low pressure means that the pressure in each flow channel 112 is lower than elsewhere around 118 the object of measurement 116, where, for instance, a normal atmospheric pressure of about 101 kPa may prevail.

In an embodiment, the pressure generator 102, which may comprise an ejector or an electromechanical low-pressure pump, for instance, sucks gas towards itself and thus directs low pressure at a predetermined operating efficiency to each flow channel 112 of the measuring head 100. Between the pump and the object of measurement it is possible to place a throttle, by means of which the operating efficiency of the device may be controlled. The low pressure acts on the object of measurement 116 placed against the contact part 110 of the measuring head 100. In case the object of measurement 116 is not highly porous, but it strongly resists the flow of gas therethrough, the low pressure is high. In case the object of measurement 116 is highly porous and allows gas to pass easily through, the low pressure remains low. Thus, the magnitude of low pressure depends on the gas flow taking place through the object of measurement 116 and the port 112.

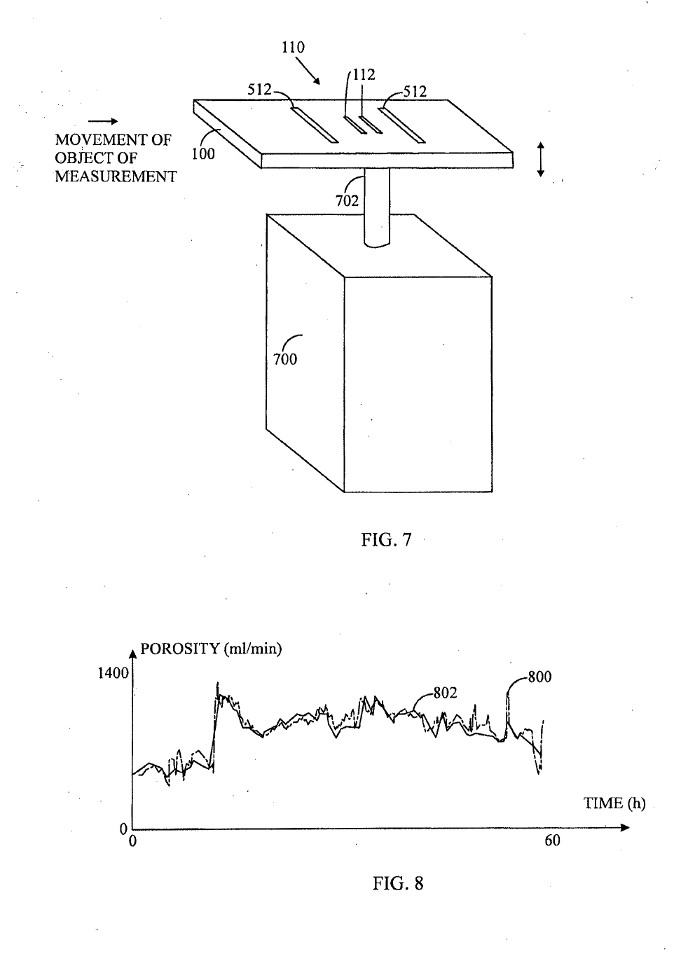

The porosity of the object of measurement may be determined with a sensor 104 by measuring the pressure prevailing in at least one port 112 in the measuring head 100. Pressure measurement may be performed in a measuring space 106, for instance. The sensor 104 may be an electronic sensor 104. A computing unit 206 (i.a. FIG. 2) may be part of a processor-based system controller, for instance. For instance, a MEMS (MicroElectroMechanical System) sensor converts pressure to an electric signal. The MEMS sensor is like a capacitor whose capacitance changes according to the pressure exerted thereon. The electric signal based on capacitance may be applied to the computing unit 206 for signal processing and/or to a display. An electric analogue signal may be converted to a digital one prior to the signal processing and/or the display. The computing unit 206, in turn, may be a computer with appropriate software, for instance. On the paper machine, the computing unit 206 may also be part of the system controller controlling the operation of the paper machine (cf. FIG. 7).

When measurement of porosity is performed by measuring pressure, it is possible to avoid direct measurement of gas flow which poses problems in prior art measurements of porosity. At the same time, it is possible to avoid problems caused by the sensitivity of flow meters to dust and moisture. Because flow meters that are prone to faults due to dust and moisture are no longer needed, dust and moisture filters are not needed either. In measurements, which are not to be performed at constant pressure, there is no need for continuous pressure control, and therefore a valve controlling pressure is not needed, or pressure control is needed infrequently, so the pressure control valve needs to be changed only infrequently, or it is not needed at all. Because many parts are reduced in number, the size and the mass of the measuring device are smaller than in prior art. This has a lowering effect on the manufacturing costs as well.

FIG. 1B shows an embodiment including, for instance, two flow channels 112, and the pressure generator 102 is connected to each one separately through gas conduits 150, for instance. Both flow channels 112 have a specific sensor 104 each, the pressure signals of which are received by the computing unit 206.

In an embodiment, the measuring device may comprise at least one drain hole 200, which may be connected to at least one port 112, or to at least one gas conduit 150 connecting the port 112 and the pressure generator 102. Each drain hole 200 may drain gas to each port 112. The size of the hole 200 may be adjustable. When the size of each hole 200 (surface area) is known and when the pressure in the measuring space 106 is known, the amount of flow passing through said at least one hole 200 is also known. The measuring device may also comprise a valve 202, which allows the drain hole 200 to be opened and closed, but the drain valve 202 is not necessary. Each drain hole 200 may be used in this manner for producing a desired low pressure in each flow channel 112. Different ports 112 may have different low pressures. In addition, each bypass flow to be produced via the drain hole 200 may contribute to keep the measuring device 100 and its components clean. By means of the bypass flow it is also possible to achieve a sufficiently high flow rate of pure gas into the pressure generator 112 (e.g. into the ejector of FIG. 3) to keep it clean. The sensor 104 in each port may measure the pressure and the computing unit 206 may receive the signal generated by the sensor 104 and determine the porosity of the object of measurement 116 on the basis of the pressure data of each port 112.

FIG. 2 shows the measuring arrangement in more detail. Also in this embodiment of the figure, the measuring device may comprise at least one drain hole 200, which may be connected to the measuring space 106, the pressure opening 108 or to the gas conduit 150 connecting at least one port 112 and the pressure generator 102. The sensor 104 may measure pressure in the gas conduit 150, instead of the actual measuring space 106, because the pressure in the gas conduit 150 is the same as or proportional to the pressure in the measuring space 106. The measuring sensor 104 generates a signal that contains pressure data. The computing unit 206 may receive the signal generated by the sensor 104 and determine the porosity of the object of measurement 116 on the basis of the pressure data.

Instead of uniform pressure, the pressure in the measuring space 106 may be brought to vary in a predetermined manner. Pressure variation may be generated, for instance, by opening and closing the valve 202, or the predetermined operating efficiency of the pressure generator 102 may be implemented by altering the operating efficiency of the pressure generator 102 in a predetermined manner. The pressure may vary according to a predetermined function, for instance. The predetermined function may be a sine function, for instance. The computing unit 206 receives the signal generated by the measuring sensor 104 and determines the porosity of the object of measurement 116 on the basis of a varying low pressure. Because a varying pressure range that behaves in a predetermined manner is available, the measurement is more accurate than the measurement performed by means of constant pressure. For instance, it is possible to detect whether the porosity changes linearly or non-linearly in relation to the low pressure.

FIG. 3 shows an embodiment, in which the pressure generator 102 may comprise an electropneumatic transducer 302. The pressure generator 102 may also comprise an ejector 300. There may be a plurality of electropneumatic transducers and ejectors, and one electropneumatic transducer may supply pressure to more than one ejector. Generally defined, the ejector comprises a flow-through pipe with an interfitting pipe to a T-branch. When gas is flown through the ejector, suction is provided in the T-branch. The electropneumatic transducer 302 may supply gas or liquid at a predetermined pressure to the ejector 300, so that the ejector 300 will operate at a predetermined operating efficiency with different amounts of suction. The electropneumatic transducer 302 may receive gas at a pressure of e.g. 600 kPa, and the electropneumatic transducer 302 may supply gas into the ejector 300 at a pressure which may be any constant pressure in the range of 110 kPa to 600 kPa, for instance. In addition, the electropneumatic transducer 302 may control the predetermined gas pressure so as to control the predetermined operating efficiency of the ejector 300. The pressure generated by the electropneumatic transducer 302 may be measured with a pressure gauge 304 and thus the pressure may be controlled to be as desired. Instead of the electropneumatic transducer 302, it is also possible to use an electrohydraulic transducer, whereby liquid is flown through the ejector 300, instead of gas.

In an embodiment the electropneumatic transducer 302 may control the predetermined gas pressure to adjust the low pressure produced by the ejector 300 to be as desired in the measuring space 106, which enables porosity measurement to be performed at standard pressure. Thus, the pressure in the measuring space 106 may be set, for instance, 1.47 kPa lower than on the other side 118 of the object of measurement 116, as defined in Bendtsen porosity measurement. In that case, when gas flow is measured by a flow meter 130, the porosity measurement may be performed according to the standard. Yet the determination of a porosity value does not require the flow meter 130, nor the result of flow measurement, because measurement of pressure in the measuring space 106 will be sufficient to determine the porosity as well as the amount of gas flow, because the flow rate depends on the pressure in the measuring cell 106 (measurable) and the operating efficiency of the pressure generator 300 (predetermined/known). In a measurement of this kind it is possible to alter the pressure produced by the ejector 300 by controlling the supply pressure of the electropneumatic transducer 302 to the ejector 300. The measurement performed by the ejector 300 has an advantage that filtering of dirt, dust and moisture is not necessarily needed. First, the flow meter and the relating filament need not be protected from dirt, dust and moisture. Further, because the ejector 300 does not comprise moving mechanical parts, nor electronic components or parts, the ejector 300 need not be protected from dirt, dust and moisture accompanying the gas that flows through the ejector 300. Namely, dirt and dust are not able to deposit on the ejector 300. The moisture alone does not disturb the operation of the measuring device either, because the gas flow takes the moisture with it and does not affect the operation of the ejector 300 or the measuring device. In addition, ejectors may be made for different flow rates and pressures, and commercially available ejectors are manufactured for different flow rates and pressures. By changing the ejector the measurement is easily scalable for various porosity ranges: for low porosities there are employed ejectors for low flow rates, whereas for high flow rates it is possible to select an ejector through which more air may flow.

The ejector 300 may be brought to produce in the measuring space 106 a pressure that varies in a predetermined manner by altering the output pressure of the electropneumatic transducer 302 in a predetermined manner. In this way it is possible to produce a sinusoidally varying pressure in the measuring space 106.

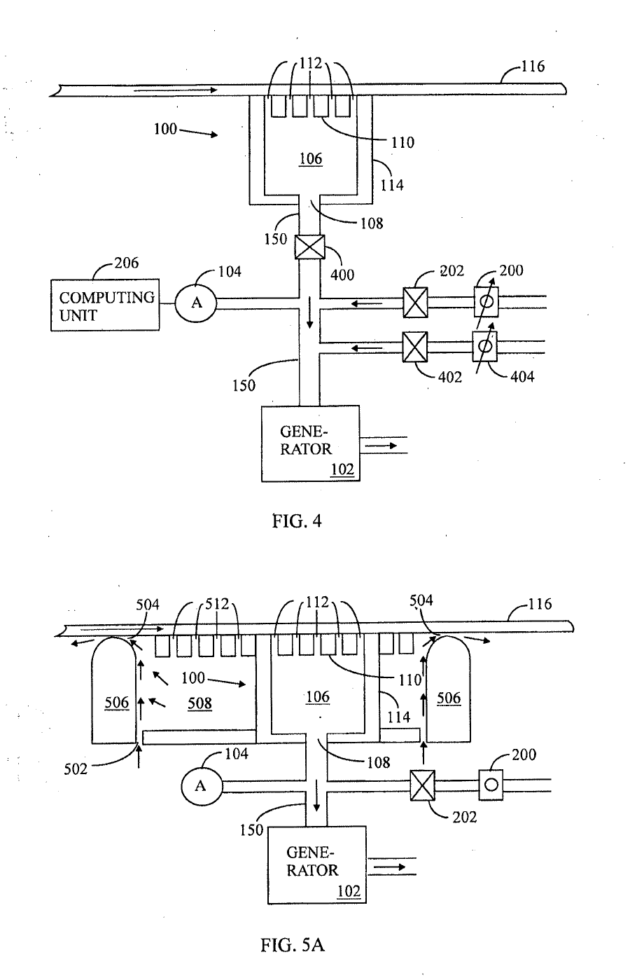

FIG. 4 shows an embodiment, in which the measuring device may carry out calibration measurement at desired time instants. For this purpose the measuring device may comprise at least two closing means 400 and 402, which may be ball valves, for instance. The closing means 400 may reduce the gas flow, produced by the pressure generator 102, through at least one port 112 to a predetermined level for performing the calibration. For instance, the closing means 400 may close the gas flow from each port 112 of the measuring head 110 to the pressure generator 102. The calibration valve 402, in turn, may open a connection to at least one reference opening 404, the size of which is predetermined, in order to enable gas flow from the reference opening 404 towards the pressure generator 102. Because the size of the reference opening 404 is predetermined, the magnitude of the gas flow passing therethrough in relation to the pressure difference over the reference opening 404 (the operating efficiency of the pressure generator 102) is known. The pressure between the calibration valve 402 and the pressure generator 102 may be measured with a sensor 104. The computing unit 206 may correct the transformation by which the result of porosity measurement is obtained from the pressure, in case the measured pressure deviates from the known pressure more than what is predetermined. In this embodiment, the drain hole 200 and at least one valve 202 may be included or not included in the measuring device.

In an embodiment both the calibration and the drain flow are implemented by the same structure. In that case, when the gas flow produced by the pressure generator 102 through at least one port 112 is reduced with the closing means 400 to a predetermined level, the predetermined gas flow needed in the calibration may come through at least one hole 202 the size of which is predetermined and which serves as at least one reference opening 404. The calibration of the measuring device is described in greater detail in connection with FIG. 6.

The size of at least one reference opening 404 may be adjustable. At least one reference opening 404 may be round and its diameter may be 1 mm, for instance, without being restricted thereto, however. At least one reference opening 404 may also be other than round in shape. At least one reference opening 404 may be polygonal in shape, for instance.

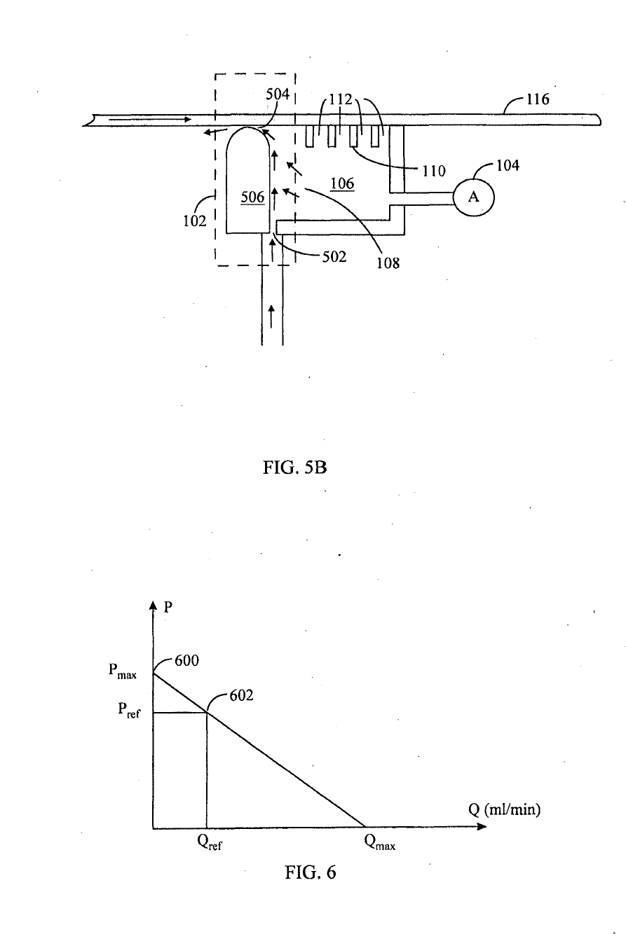

FIG. 5A shows an embodiment, in which the measuring head 106 comprises a contact part 110 for bringing the object of measurement 116 into contact with the measuring head 100 for the measurement. The contact part 110 comprises a nozzle gap 502, a gap 504 and a guide structure 506. The nozzle gap 502 may receive a gas flow from an external pressure container or gas pump, which gas flow discharges from the nozzle gap 502 into a gas space 508 generating low pressure. The guide structure 506 may guide the gas along its surface and allow the gas to discharge through the gap 504, which also contributes to the generation of low pressure between the object of measurement 116 and the measuring head 100, which low pressure draws the object of measurement 116 towards the measuring head 100 via at least one suction hole 512.

The contact part 500 is examined still in more detail. The gap 504 and at least one suction hole 512 may appear, seen from above, as a circular groove around said at least one port 112, for instance. Alternatively, the gap 504 and at least one suction hole 512 may form, for instance, two straight grooves on different sides of said at least one port 112 of the contact part 110. The nozzle gap 502 may provide a kind of surface current nozzle. From the nozzle gap 502 the gas may discharge towards the object of measurement 116, and a curved guide structure 506 locating in the immediate vicinity of the nozzle gap 502 may divert the gas flow away from the measuring head 100. In that case the gas flows as shown by the arrows. The low pressure, formed by the effect of the surface current nozzle, affects the gas space 508 below the contact part 110. In addition, the low pressure of the surface current nozzle acts via the suction holes 512 in the contact part 110, which are not ports 112 leading to the measuring space 106, on the object of measurement 116 in such a manner that by the effect of the low pressure the object of measurement 116 is supported to the contact part 110. The gas pressure and, along therewith, also the gas flow rate may be arranged to a desired level such that the gas flow produces a desired low pressure which draws the object of measurement 116 towards the measuring head 100. The curved guide structure 506 may be located and constitute a part of the gap 504 in the surrounding frame structure of the measuring head 100, or in a form element surrounding the gap 504.

Said at least one port 112 of the contact part 110 may be located in the contact part 110 in such a way that the moving object of measurement 116 may set straight and flat against the contact part 110 and said at least one port 112. The hole pattern of the ports 112 in the contact part 110 may vary in a variety of ways. In the ports 112 the ratio of open to closed portions may vary as well as the cross-sectional size of the ports. The ports 112 may be designed such that they are sufficiently large to let through dust produced by the object of measurement 116 or other impurities, yet sufficiently small in such a way that the object of measurement 116 supported to the contact part 110 is not allowed to wave or wrinkle, but it sets evenly against the contact part 110. The same characteristics also apply to the suction holes 512 in the contact part 110.

As shown in FIG. 5A, the measuring device may or may not include at least one drain hole 200 with valves 202

FIG. 5B shows an embodiment, in which gas is supplied through a pressure opening 108 into a measuring space 106. The gas may come from a pneumatic apparatus. The pressure opening 108 serves as a tiny nozzle gap the diameter of which may be from tens to hundreds of micrometres, for instance. In the measuring space 106, the gas mainly propagates along the guide structure 506 and is discharged from the gap 504 between the object of measurement and the guide structure, producing low pressure in the ports 112. Parts 106, 108, 112, 504 and 506 actually constitute a pressure generator 102 which operates like an ejector. The low pressure draws the object of measurement 116 towards the measuring head 100, and the low pressure may be measured with a sensor 104 and the porosity may be determined by a computing unit 206. In that case the low pressure used for measurement also serves as the low pressure holding the object of measurement 116 against the measuring head 100.

FIG. 6 illustrates the operation of a pressure generator 102. The vertical axis denotes pressure on a freely selected scale and the horizontal axis denotes gas flow rate on a freely selected scale. If an object of measurement 116 completely impermeable to gas, such as a glass or metal plate, is set on the contact part 110, or the closing means 400 are closed completely, the pressure in the measuring space 106 is measured to be Pₘₐₓ, following the curve of FIG. 6, which is the highest pressure the pressure generator 102 produces with a predetermined operating efficiency. In that case the flow Q is about zero (or a small minimum flow Qₘᵢₙ). If the closing means 400 are completely closed and the calibration valve 402 is opened to at least one reference opening 404, the gas flow will be set to a predetermined level Q_{ref}. In that case, the pressure should also set to a previously known pressure P_{ref}. This is based on the fact that, because the size of the reference opening 404 is known and the low pressure is measured, the amount of gas flow Q_{ref} can be determined on the basis of the low pressure and the size of the reference opening 404. Between these two points 600, 602 it is possible to determine, for instance, a linear dependence, which corresponds to a straight line in FIG. 6. More generally, the closing means 400 may reduce the gas flow provided by the pressure generator 102 through at least one port 112 to a predetermined level, whereby one calibration point 602 may be determined on a desired curve of function representing pressure and flow. There may be a plurality of predetermined, known openings, whereby a plurality of calibration points will be obtained.

In addition, it is possible to carry out a measurement, in which no sample is placed on the contact part 110. Thus, the pressure in the measuring space 106 is measured to be the value at the second end of the curve, which corresponds to a pressure difference of about 0. The amount of gas flow will be the highest possible value Qₘₐₓ, which may be measured in cubic millimetres per second, for instance. Any value between these values indicates a porosity of some degree in the object of measurement 116. The curve for the ejector is almost straight, i.e. the measured pressure and the gas flow rate, which corresponds to porosity, are in linear, or almost linear, interdependence. Thus, the computing unit 206 may determine at least one parameter (Q_{ref}, P_{ref}) for porosity measurement on the basis of the measured pressure. The computing unit 206 thus determines the calibration points on the basis of the measured pressures and the known ports.

In a general case, the computing unit 206 may determine the flow rate Q from the pressure p, for instance, according to the following formula:

Q=f(p,Pₘₐₓ,p_{ref},Qₘₐₓ),

where f is a predetermined function, p is a measured pressure, Pₘₐₓ is the highest possible pressure, p_{ref} is a pressure value measured with a reference flow of gas alone, Q_{ref} is the gas flow rate to be determined, which allows porosity of the object of measurement 116 to be determined. When there is at least an approximately linear dependence between the pressure and the flow rate, the computing unit 206 may determine the flow rate Q from the pressure p, for instance, by formula:

$$Q = \frac{p - {P}_{Max}}{{p}_{ref} - {P}_{Max}} {Q}_{ref} .$$

In an embodiment the measuring device may supply pressurized gas through the measuring arrangement in an opposite direction to the measuring direction. The pressure of the pressurized gas may be the same as the input pressure of the electropneumatic transducer 302, i.e. 600 kPa. In that case the pressurized gas may be supplied into the pressure generator 102, wherefrom the pressurized gas proceeds towards the measuring space 106 and finally through the port 112 out of the measuring device. Thus, the dust and dirt possibly adhering to the measuring system can be removed and blown away from the measuring device. Cleaning blow of this kind may take, for instance, less than a second or a few seconds, and it may be repeated on an hourly, daily or weekly basis, for instance, if cleaning is needed. In any case, cleaning is so quick that it does not disturb much the continuous measurement, and it may be performed beside the web, for instance.

FIG. 7 illustrates the principle of the structure of the measuring device. In the measuring head 100 there are depicted two ports 112 and two suction holes 512 on either side thereof. The measuring device may comprise a frame structure 700 and a bar 702. The measuring head 100 may be at the end of the bar 702. The bar 702 may be raised and lowered to an appropriate height below the object of measurement 116. The frame structure 700 may comprise a lifting device by which the bar 702 may be raised and lowered. The lifting device may be hydraulic, pneumatic or electromechanical. The pressure generator 102 may also be located in the frame structure 700, and low pressure may be generated for the measuring space 106 through a gas conduit 150. For instance, on a paper machine the measuring device may be a structure traversing throughout the entire width of the web, a mini-traversing structure or a fixed structure. It is obvious to a person skilled in the art that the principle of the structure of the measuring device shown in FIG. 7 is just an example, which may be modified in a variety of ways within the scope of the accompanying claims. For instance, the size and proportions of the measuring device and the measuring head may vary greatly. For instance, it may be possible that the measuring head 100 extends throughout the entire width of the object of measurement. Because of the low cost of the structural components of the measuring device it is also possible that the measuring device comprises several measuring heads, and thus the measuring device may be arranged accordingly to measure the porosity of the object of measurement simultaneously substantially throughout the entire width of the object of measurement.

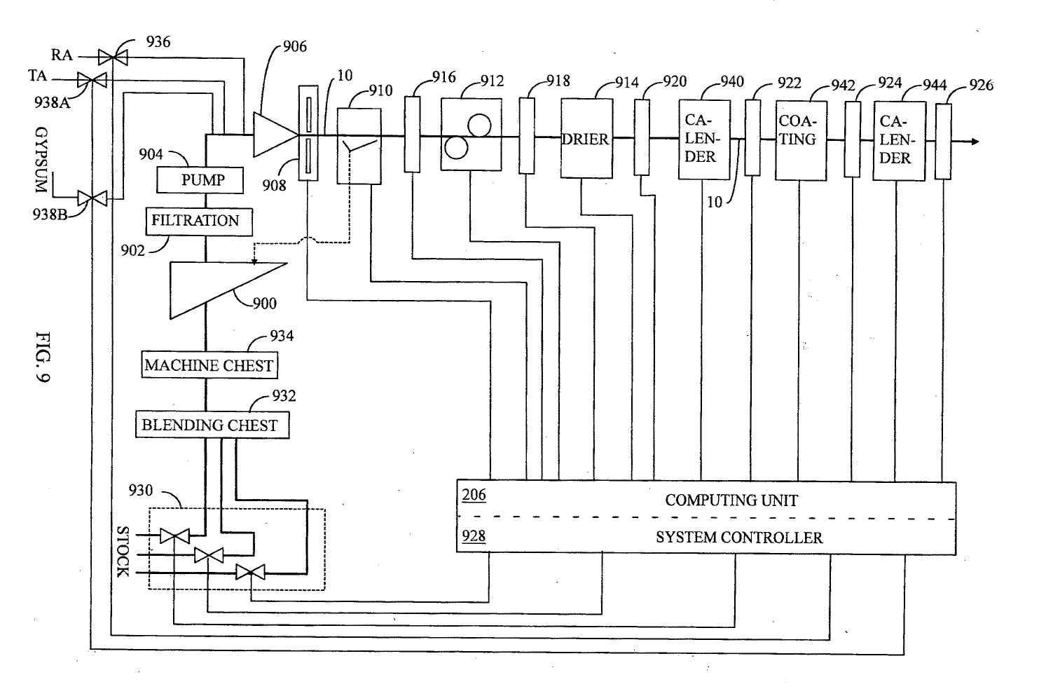

FIG. 8 shows measurements 802 of the present solution in comparison with standard measurements 800 carried out in laboratory. The vertical axis denotes porosity (ml/min) and the horizontal axis denotes time T in hours. The present pressure-based measuring device of porosity was not cleaned or serviced in any way during the entire measurement period, yet the device worked faultlessly, even though more than 30% of the pulp consisted of recycled fibre most of the time. As appears from FIG. 8, the on-line measuring device gives very closely the same values for porosity as the laboratory measurement. The presented solution makes it possible to achieve the same accuracy in the reproducibility of measurements as the prior art laboratory measurements. A standard deviation in the reproducibility of porosity may be 0.2%, for instance.

FIG. 9 shows the structure of a paper machine in principle. In this solution, the object of measurement 116 is a paper web 10. One or more stocks are fed onto a paper machine through a wire pit silo 900, which is usually preceded by a blending chest 932 for partial stocks and a machine chest 934. The machine stock is dispensed for a short circulation, for instance, controlled by a basis weight control or a grade change program. The blending chest 932 and the machine chest 934 may also be replaced by a separate mixing reactor (not shown in FIG. 9), and the dispensing of the machine stock is controlled by feeding each partial stock separately by means of valves or another flow control means 930. In the wire pit silo 900, water is mixed into the machine stock to obtain a desired consistency for the short circulation (dashed line from a former 910 to the wire pit silo 900). From the obtained stock it is possible to remove sand (centrifugal cleaners), air (deculator) and other coarse material (pressure filter) using cleaning devices 902, and the stock is pumped with a pump 904 to a headbox 906. Before the headbox 906, it is possible to add to the stock, in a desired manner, a filler TA, including e.g. gypsum, kaolin, calcium carbonate, talcum, chalk, titanium dioxide and diatomite etc. and/or a retention agent RA, such as inorganic, inartificial organic or synthetic water-soluble organic polymers. With fillers it is possible to reduce the porosity in the paper web, for instance, because fine-grained filler tends to fill air channels and cavities. This is observed in formation and surface properties, opacity, brightness and printability. The retention agents RA, in turn, increase the retention of the fines and fillers while speeding up dewatering in a manner known per se. Both the fillers and the retention agents thus affect the structural properties of the paper, such as porosity, which can be seen in optical properties and smoothness of surface as well as topography.

From the headbox 906 the stock is fed through a slice opening 908 of the headbox to a former 910, which may be a fourdrinier wire or a gap former. In the former 910, water drains out of the web 10 and additionally ash, fines and fibres are led to the short circulation. In the former 910, the stock is fed as a web 10 onto a wire, and the web 10 is preliminarily dried and pressed in a press 912, which affects porosity. The web 10 is actually dried in driers 914. Conventionally, the paper machine comprises at least one measuring device component 920 to 926, which comprises a measuring head 100 and a sensor 104. In the cross direction of the web 10 there may be a row of several measuring device components for measuring a cross-directional porosity profile of the web 10. With the measuring device components 916 and 918 it is possible to perform other measurements known per se. The sensor 104 measures the pressure relating to the porosity of the web 10. In addition, at least one measuring device component 920 to 926 may comprise a common pressure generator 102 or a separate one for all. A system controller 928 may receive directly signals relating to the pressure measurement by the measuring device components 920 to 926, the signals representing porosity, and control various actuators on the basis of the pressure measurement. Alternatively, the system controller 928 may comprise a computing unit 206, whereby the signals from the measuring device components 920 to 926 may first proceed to the computing unit 206, and on the basis of the porosity data generated by said computing unit the system controller 928 may control the paper machine.

Each measuring device component 920 to 926 may comprise a plurality of measuring heads 100 and sensors 104, which are in a row in the cross direction of the web 10 so that the porosity profile of the web 10 can be measured. The row of measuring heads may obtain its low pressure from one pressure generator, or there may be at least two pressure generators, whereby at least two measuring heads in the row of measuring heads may be connected to different low-pressure generators. When one measuring head 100 measures the porosity profile of the web 10, the measuring head 100 may traverse the web 10 from edge to edge in the cross direction.

The paper machine, which in connection with this application refers to paper or board machines, may also include a pre-calender 940, a coating section 942 and/or a finishing calender 944, the operation of which affects the porosity. It is not necessary to have the coating section 942, however, and therefore it is not necessary to have more calenders 940, 944 than one. In the coating section 942, coating paste, which may contain e.g. gypsum, kaolin, talcum or carbonate, starch and/or latex, may be spread onto paper. The coating paste adheres to the paper web 10 the better the more porous the web is. On the other hand, the porosity of a coated paper web 10 is lower than that of an uncoated paper web. The uniformity of the cross-directional profile of porosity is essential to uniform distribution of the coating agent.

In calenders 940, 944, where the uncoated or coated paper or board web runs between the rolls pressing with desired force, it is possible to change the porosity of the paper. In the calenders 940, 944, the properties of the paper web may be changed by means of web moistening, temperature and nip pressure between the rolls such that the higher the pressure exerted on the web, the lower the porosity becomes and the smoother and glossier the paper will be. Moistening and raised temperature may further reduce the porosity. In addition to this, it is clear that the operation of a paper machine is known per se to a person skilled in the art, and therefore, it need not be presented in greater detail in this context.

The system controller 928, which may perform signal processing, may control various process of the paper machine on the basis of the measured pressure such that porosity in the paper to be manufactured, together with other properties, will meet the set requirements. The system controller 928 may also present the measured porosity value graphically and/or numerically on a desired scale and according to a desired standard on a display, for instance.

In an embodiment, the thickness of the object of measurement 116, 10 may be determined on the basis of the measured porosity. In that case, the computing unit 206 may know in advance the basis weight of the object of measurement 116, 10, or the computing unit 206 may receive information on the basis weight of the object of measurement 116, 10. The basis weight may be measured by means of β radiation or optical radiation dampening. When the computing unit 206 simultaneously receives information on the measured pressure, which depends on the porosity of the object of measurement 116, 10, the thickness of the object of measurement 116, 10 may be determined as a function of the basis weight and the measured pressure or the determined porosity. The measurement of thickness is based on the fact that the density of the object of measurement 116, 10 corresponds to the basis weight divided by thickness. Bulk, in turn, is an inverse of density, and in certain conditions the bulk and the porosity correlate excellently. Thus, in principle, the thickness of the object of measurement is the product of the basis weight and the porosity. Generally, the thickness of the object of measurement 116, 10 may be defined by a predetermined function, the arguments of which include the basis weight and the porosity (or measured pressure). The predetermined function may be defined experimentally, for instance. In test measurements conducted the thickness of the object of measurement 116, 10 could be measured very accurately.

In an embodiment, on the basis of the determined thickness it is also possible to determine the opacity of the paper, because the opacity and the thickness are basically opposites to one another in such a way that as the thickness increases, the opacity decreases, and vice versa. The measurement of opacity may be made more accurate, if additionally moisture and/or ash distribution in the paper are measured, because the moisture and the ash distribution of the paper affect the opacity.

In an embodiment, the thickness of paper may be measured by means of opacity. The measurement of thickness performed in this manner may also be made more accurate, if additionally the moisture and/or ash distribution of the paper are also measured.

FIG. 9 also shows a control arrangement of a paper machine. Factors affecting the porosity of paper include, inter alia, the number and mutual proportion of partial stocks, the amount of filler, the amount of retention agent, machine speed, the amount of white water and drying capacity. On the basis of the pressure data or the determined porosity, the system controller 928 may control various actuators, which may include, for instance, dispensing of partial stocks by means of valves 930, dispensing of each filler TA by means of valves 938A to 938B, dispensing of retention agent RA by means of valve 936, adjustment of the size of slice opening 908, adjustment of machine speed, control of the amount of white water and the drying processes in block 914. The system controller 928 may receive the signal from the measuring device components 916 to 926 so as to measure the porosity of the web 10. The system controller 928 may also measure the properties of the web 10 elsewhere (e.g. at the same locations where controls are performed).

If the measurement shows that the paper is excessively porous (pressure excessively high), the system controller 928 may, for instance, increase the amount of a fine-grained substance (fine, filler, retention agent), increase pressing between the rolls (nip pressure), increase drying capacity, increase moistening or carry out a combination of the above-mentioned operations.

If the measurement shows that the paper is too little porous (pressure too low), the system controller 928 may, for instance, decrease the amount of a fine-grained substance (fine, filler, retention agent), decrease pressing between the rolls (nip pressure), decrease drying capacity, decrease moistening or carry out a combination of the above-mentioned operations.

The system controller 928 may be conceived as a paper machine's control arrangement, or part thereof, based on automatic data processing. The system controller 928 may receive digital signals or convert the received analog signals to digital ones. The system controller 928 may comprise a microprocessor and memory and execute the signal processing and the paper machine control in accordance with appropriate computer programs. The operating principle of the system controller 928 may be, for instance, PID (Proportional-Integral-Derivative), MPC (Model Predictive Control) or GPC (General Predictive Control) control.

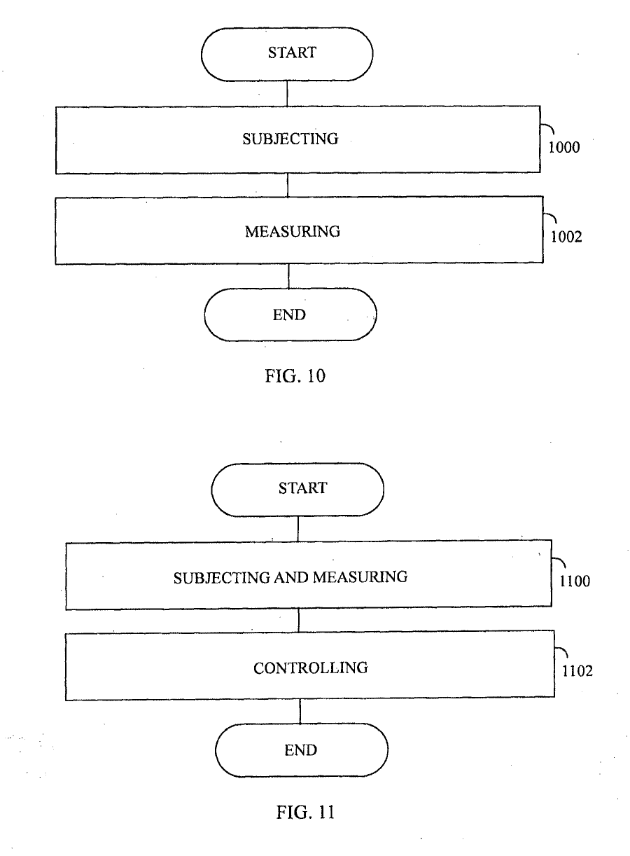

FIG. 10 is a flow chart of the measuring method. In step 1000, the paper or board is subjected to known suction effect. In step 1002, the low pressure generated by the suction effect is measured for determining the porosity.

FIG. 11 is a flow chart of the control method. In the control method, in accordance with the measuring method, in step 1100, the paper or board is subjected to known suction effect and the low pressure generated by the suction effect is measured for determining the porosity. In step 1102, on the basis of the measured pressure data, the system controller 928 controls at least one actuator of the machine manufacturing the object of measurement 10, 116 to adjust the porosity in the object of measurement.

The methods shown in FIGS. 10 and 11 may be implemented as a logic circuit solution or computer program. The computer program may be placed on a computer program distribution means for the distribution thereof. The computer program distribution means is readable with a data processing device and it may encode the computer program commands to control the operation of the measuring device.

The distribution means, in turn, may be a solution known per se for distributing a computer program, for instance a computer-readable medium, a program storage medium, a computer-readable memory, a computer-readable software distribution package, a computer-readable signal, a computer-readable telecommunication signal or a computer-readable compressed software package.

Even though the invention is described above with reference to the examples of the attached drawings, it is clear that the invention is not restricted thereto, but it may be modified in a variety of ways within the scope of the accompanying claims.

1. A measuring device for measuring porosity of an object of measurement, wherein the measuring device comprises at least one ejector configured to allow dirt, dust and moisture flow therethrough unfiltered, and the measuring device is arranged to direct known suction effect provided by said at least one ejector to paper or board, constituting the object of measurement and to measure the low pressure produced by the suction effect for determining the porosity without a flow meter.

2. The measuring device of claim 1, wherein the measuring device comprises at least one sensor, and the measuring device is arranged to measure the low pressure produced by said suction with the sensor.

3. The measuring device of claim 2, characterized in wherein the measuring device comprises at least one measuring head and at least one low-pressure generator;
said at least one measuring head comprises at least one contact part, which is intended for being in contact with the object of measurement moving in relation with the measuring head and which comprises at least one port;
said at least one pressure generator is arranged to operate at a predetermined operating efficiency and said at least one ejector is arranged to direct low pressure, at said operating efficiency of the pressure generator, to said at least one port, the magnitude of the low pressure depending on the porosity of the object of measurement;
said at least one sensor is arranged to measure the low pressure prevailing in said at least one port and to generate a signal containing low-pressure data for determining the porosity of the object of measurement.

4. The measuring device of claim 3, wherein each measuring head incorporates at least one measuring space, and the measuring head comprises at least one pressure opening for gas flow between each pressure generator and each measuring space;
said at least one pressure generator is arranged to produce, at said operating efficiency, a low pressure in at least one measuring space via at least one pressure opening, the magnitude of the low pressure depending on the gas flow passing through the object of measurement and the port.

5. The measuring device of claim 3, wherein at least one sensor is arranged to measure pressure in the measuring device between the contact part and the pressure generator.

6. The measuring device of claim 3, wherein the measuring device comprises at least one drain hole, which is arranged to let gas between the contact part and the pressure generator.

7. The measuring device of claim 3, wherein at least one pressure generator comprises an ejector and the measuring device comprises at least one electropneumatic transducer, which is arranged to supply gas at a predetermined pressure to at least one ejector in order to make it operate at the predetermined operating efficiency.

8. The measuring device of claim 3, wherein the measuring device also comprises a computing unit, which is arranged to receive a signal containing pressure data and to determine the porosity of the object of measurement on the basis of the pressure data.

9. The measuring device of claim 8, wherein the measuring device is arranged to perform calibration measurement at desired time instants, for which the measuring device comprises at least one set of closing means and the computing unit; and
each closing means is arranged to reduce the gas flow provided by each ejector of the pressure generator through at least one port to a predetermined level; and
at least one sensor is arranged to measure pressure in the measuring device between the closing means and the pressure generator; and
the computing unit is arranged to determine at least one parameter for porosity measurement on the basis of the measured pressure.

10. The measuring device of claim 3, wherein the measuring head comprises at least one measuring space, which comprises at least one guide structure;
at least one pressure opening is arranged to receive from the ejector of the pressure generator a gas flow that is directed towards at least one measuring space space;
each guide structure is arranged to guide the gas along its surface and to lead the gas out of the measuring space between the guide structure and the object of measurement, and the sensor is arranged to measure thus obtained low pressure which draws the object of measurement towards the measuring head.

11. A method for measuring porosity in a moving object of measurement, comprising directing known suction effect provided by at least one ejector to paper or board, constituting the object of measurement, dirt, dust and moisture flowing through the ejector unfiltered during the measurement, and measuring the low pressure produced by the suction effect for determining the porosity without a flow meter.

12. The method of claim 11, comprising directing suction with the pressure generator to the object of measurement at a predetermined strength through each ejector and measuring the low pressure produced by said predetermined suction with the sensor.

13. The method of claim 11, comprising performing measurement by using at least one measuring head which comprises at least one contact part intended to be in contact with the object of measurement moving in relation to the measuring head and which comprises at least one port, the method comprising
directing low pressure, produced by the ejector, at a predetermined operating efficiency of at least one pressure generator, in said at least one port, which low pressure acts on the object of measurement against the contact part of the measuring head and the magnitude of which low pressure depends on the gas flowing through the object of measurement and the port of the measuring head;
measuring with at least one sensor the pressure prevailing in each port and generating with each measuring sensor a signal containing pressure data for measuring the porosity of the object of measurement.

14. The method of claim 13, comprising performing measurement by using at least one measuring head, each of which comprising a surface incorporating a measuring space and including at least one pressure opening for gas flow between each pressure generator and each measuring space;
producing by said at least one pressure generator, at said operating efficiency, a low pressure in at least one measuring space via at least one pressure opening, the magnitude of the low pressure depending on the gas flow passing through the object of measurement and the port.

15. The method of claim 13, comprising measuring the low pressure with at least one sensor between the contact part and the pressure generator.

16. The method of claim 13, comprising letting gas through at least one drain hole between the contact part and the pressure generator.

17. The method of claim 13, wherein at least one pressure generator comprising an ejector and the measuring device comprising at least one electropneumatic transducer, each electropneumatic transducer supplies gas, at a predetermined pressure, to at least one ejector in order to make it operate at the predetermined operating efficiency.

18. The method of claim 13, comprising receiving in the computing unit a signal containing pressure data and determining by the computing unit the porosity of the object of measurement on the basis of the pressure data.

19. The method of claim 13, comprising performing calibration at desired time instants
by reducing with closing means the gas flow provided by the pressure generator in at least one ejector through at least one port to a predetermined level;
by measuring with the sensor pressure in the measuring device between the closing means and the ejector of the pressure generator; and
by determining in the computing unit at least one parameter for porosity measurement on the basis of the measured pressure.

20. The method of claim 13, wherein at least one measuring head comprises at least one measuring space, which comprises at least one guide structure;
at least on pressure opening receives from the ejector of the pressure generator a gas flow that is directed towards at least one measuring space;
each guide structure guides the gas along the surface of the guide structure and leads the gas out of each measuring space between the guide structure and the object of measurement and the sensor measures thus obtained low pressure which draws the object of measurement towards the measuring head.

21. A control arrangement of a machine manufacturing an object of measurement for controlling the porosity of the object of measurement, wherein the control arrangement comprises
a measuring device in accordance with claim 1; and
a system controller which is arranged to control at least one actuator of the machine manufacturing the object of measurement on the basis of the measured pressure data.

22. The control arrangement of claim 21, wherein the system controller comprises a computing unit which is arranged to receive from the measuring device a signal containing pressure data on the object of measurement and representing the porosity, and to generate the porosity information on the object of measurement on the basis of the pressure data; and the system controller is arranged to control at least one actuator of the machine manufacturing the object of measurement on the basis of the porosity information to control the porosity of the object of measurement.

23. A control method of a machine manufacturing an object of measurement for controlling the porosity of the object of measurement, wherein the control method comprises
the method of claim 11;
and a step, in which, on the basis of the measured pressure data, the system controller controls at least one actuator of the machine manufacturing the object of measurement to adjust the porosity in the object of measurement.

24. The control method of claim 23, comprising determining in the computing unit of the system controller the porosity data on the basis of the pressure data; and
controlling with the system controller at least one actuator of the machine manufacturing the object of measurement to adjust the porosity of the object of measurement on the basis of the determined porosity data.
